(19) United States
(12) Patent Application Publication
(10) Pub. No.: US 2023/0348176 A1
(43) Pub. Date: Nov. 2, 2023

(54) COMPOSITE MATERIAL HAVING A COMPONENT OBTAINED FROM THE SILVER SKIN OF THE COFFEE CHERRY AND PORTION CAPSULE COMPRISING SAID COMPOSITE MATERIAL

(71) Applicant: Tchibo GmbH, Hamburg (DE)

(72) Inventor: Helena von Staden, Hamburg (DE)

(21) Appl. No.: 17/922,877

(22) PCT Filed: May 6, 2021
(86) PCT No.: PCT/EP2021/062069

§ 371 Date: Nov. 2, 2022

(30) Foreign Application Priority Data
May 8, 2020 (EP) 20173767.3

(51) Int. Cl. B65D 85/804; B65D 65/46

(52) U.S. Cl. CPC B65D 85/8043; B65D 65/466; B65D 2221/00

(57) ABSTRACT

A beverage, particularly coffee, is prepared using a portion capsule. The portion capsule has a base element for receiving an extraction product. Further, a method for producing the portion capsule, a composite material able to be produced particularly efficiently in the setting of producing coffee portion capsules, and a method for producing the composite material. The composite material includes a component produced from silver skins of coffee cherries. The portion capsule includes the composite material.

### BACKGROUND OF THE INVENTION

### Field of the Invention

The invention relates to the field of devices and methods for preparing beverages by means of a liquid introduced into a beverage capsule, the beverage capsule including a soluble food substance from which a beverage or beverage component can be prepared by injecting water. The invention particularly relates to the field of preparing coffee using a coffee capsule. The invention relates particularly to a portion capsule, a method for preparing the portion capsule, a composite material capable of being produced particularly efficiently in the context of coffee capsule production, and a method for producing the composite material.

### Description of Related Art

Among the systems for preparing beverages, so-called coffee capsule systems (there are also variants for preparing tea) are known for which, in general, hot water is introduced into a capsule, typically under pressure, in order to prepare a coffee or tea beverage by extraction. The capsule is often pierced on one side (injection side) thereof for introducing the hot water. For discharging the brewed beverage on the other side of the capsule (the extraction side), in general, various possibilities are known. For one, there are systems in which piercing by means of corresponding perforation mandrels is provided on the extraction side as well. For another, systems are known in which a boundary of the capsule on the extraction side is pierced or torn under the interior pressure during the brewing process, for which a means external to the capsule (present in the brewing chamber of the corresponding coffee machine) or a means internal to the capsule can be present. Finally, there are also capsules already having been opened, for which no capsule wall/membrane needs to be pierced or torn in order to discharge the beverage.

The most common are capsules made of materials including neither biodegradable nor renewable raw materials. A high share of the capsules are made of, e.g., aluminum or polypropylene (PP). Such capsules can have advantageous properties both for storing (e.g., impermeability, particularly impermeability to air/oxygen) and for the application (e.g., thermal dimensional stability, piercing behavior, etc.). A great disadvantage of these capsules is the waste occurring after use and the required high effort for recycling the materials used in the capsules. The latter includes collecting the capsules, typically used in the private sphere, transporting the same to recycling facilities, and the recycling process itself. In other words, even for recycling, significant resources (time, energy, and transport costs) must be expended and can in turn impact the environment (e.g., CO₂ emissions for transporting and for obtaining the energy required for recycling). The extraction product present in the capsule also typically is lost during recycling.

The use of less resource-intensive materials for portion capsules is per se known. The use of bio-plastics has particularly been discussed. Plastics produced from a renewable resource are referred to as such (so-called bio-based plastics). Bio-plastics are also plastics able to be biologically degraded (so-called biodegradable plastics). The plastics proposed for producing portion capsules are biodegradable and partially include a portion of bio-based plastics.

For example, WO 2011/015973 A1 discloses a capsule made entirely of biodegradable material, wherein the implementation of the membrane closing off the capsule is the primary focus of the teaching of WO 2011/015973 A1 and the material used is not addressed.

WO 2015/170358 A2 shows a biodegradable capsule made of a wood material having reinforcing elements in order to be able to resist the pressure prevailing in the capsule during the brewing process.

DE 202016104950 U1 discloses a hermetically closeable portion package or a hermetically closeable portion bag having a biodegradable capsule or a biodegradable pad, wherein the portion package or the portion bag is made entirely of biodegradable material. Bio-plastic such as polylactide (PLA) or Mater-Big are referred to as examples of the material used.

WO 2017/186743 A1 discloses the use of a bio-material for coffee and tea capsules, among other applications, wherein the bio-material is a biodegradable plastic and includes sunflower seed shells or sunflower seed hulls.

Although portion capsules made of biodegradable material and/or renewable material according to the prior art area step in the right direction with a view to careful use of resources, there is still potential for optimization in this respect.

### SUMMARY OF THE INVENTION

One object of the present invention is to further improve the resource consumption and environmental friendliness of portion capsules. A particular object of the invention is to improve the production of ready-to-use portion capsules, that is, filled with an extraction product, and to improve the disposal of used portion capsules with respect to resource utilization.

A particular object of the invention is to provide a composite material optimized with respect to resource utilization for portion capsules, particularly for coffee capsules, and a method for producing the composite material. The composite material can particularly be a bio-plastic, particularly a biodegradable bio-plastic having a high proportion of renewable resources. The composite material can particularly be biodegradable according to EN 13432 (as of the end of 2019) or ASTM 6400 (as of the end of 2019). The composite material can be fully biodegradable.

A central object of the invention is to provide a portion capsule optimized with respect to resource utilization and a method for producing such a portion capsule.

One component of coffee fruits and coffee seeds, particularly of the commercially relevant species Coffea arabica, C. canephora, C. liberica (hereinafter: coffee fruits and seeds) is what is known as the silver skin. The silver skin is the testa, a remnant of the perisperm being largely displaced by the endosperm over the course of seed development. The silver skin fully encloses the coffee beans and is therefore also present in the characteristic recess of the same. The coffee bean as a whole is in turn enclosed by the parchment (the endocarp), the pectin layer and the pulp (together: the mesocarp), and the skin (the exocarp). Details on the structure of coffee fruits and coffee seeds can be found, for example, in Mendes AJT (1942) Observações Citológicas em Coffea: VI—Desenvolvimento do embrião e do endosperma em Coffea Arabica 1, Bragantia 2 (4):115-128 or in Gassner G, Hohmann B, Deutschmann F (1989) Mikroskopische Untersuchung pflanzlicher Lebensmittel [Microscopic Investigation of Plant-Based Foods]. 5th edn. Gustav Fischer Verlag, Stuttgart (particularly illustrations 457-461).

As a rule, the silver skin is largely removed during roasting. In the starting phase of roasting, the bean undergoes an increase in volume not experienced by the silver skin. As a result, the silver skin is ruptured and separated from the roasted product and removed in the roasting apparatus, for example by means of a correspondingly designed air stream.

In other words: the silver skin accrues as a waste product of coffee roasting.

The invention is based on the idea that the silver skin of the coffee bean, particularly the silver skin as separated in the roasting process, is very suitable as a component of a composite material.

A composite material includes at least two components, a first component typically being a plastic (plastic component, plastic matrix) and a second component, different from the plastic component, also being referred to as a filler. The invention is based on the idea that silver skins of the coffee beans can be processed with little effort into a very good filler for a composite material having a plastic component, particularly for a composite material very well suited for producing portion capsules. This means that the resulting composite material has properties enabling simple reshaping into one or more food-compatible components of the portion capsule for protecting the extraction product present in the portion capsule so that storing is possible, for example for months or a few (e.g. 1, 2, or 3) years, and for enabling use in beverage preparation systems without difficulty. The latter requires, among other things, that the composite material does not deform too severely (temperature resistance, elasticity) or even rupture (tensile strength, fracture strain) under the temperatures and pressures prevailing during beverage preparation, and that said material can be pierced, and that the piercing tips/injectors can be separated from the composite material without difficulty after beverage preparation.

With respect to the sustainability of a portion capsule including the composite material, initial investigations indicate that sustainability is increased in comparison with other bio-based portion capsules. In other words, there are indications that a portion capsule including the composite material or made of the same protects the extraction product present in the portion capsule so that longer storing is possible in comparison with other bio-based portion capsules (increased shelf life). The more the portion capsule prevents the present extraction product from changing, particularly with respect to the flavor of the beverage produced, the longer the permissible storage time. It is suspected that the filler obtained from silver skin has an antioxidative effect having a positive effect on the stability of the extraction product present in the portion capsule.

The composite material can, as is per se known, include additional aggregates (additives) for adjusting the properties of the composite material.

In other words: The composite material according to the invention is preferably a plastic enhanced by aggregates, wherein one aggregate is obtained from silver skins of the coffee bean. The plastic component can be made of one or more plastics.

The use of the silver skin as a component (filler) for a composite material for portion capsules has various advantages, such as:
A waste product from producing coffee, particularly producing coffee for portion capsules, is used for the portion capsule itself. A component (filler) obtained at great effort under certain circumstances can thus be replaced by a component obtained from a waste product (that is, from silver skin). The resource consumption for producing the portion capsule is thus reduced. It is further achieved that the replaced component need not be purchased, thus reducing production costs.

Finally, transport costs and transport volumes and thus also the environmental effects of transporting can be reduced for a roastery in the vicinity of the production location of the portion capsules.
The bio-based, that is, renewable, share of the portion capsule is increased.
The biodegradability of the portion capsule remains ensured when using a biodegradable plastic component.
The entire used portion capsule can thus also be composted. The separating of compostable portions, for example the extraction product, from the non-compostable portions is thus eliminated. It is known that the extraction product, particularly coffee, can be composted very well and has a positive effect on the finished compost, particularly in the form of increased nutrient content. For standard capsules, the material of the (empty) portion capsule typically forms the non-compostable portion.
Obtaining the component from the silver skins is very simple. For example, the silver skins can be obtained during decaffeinating and/or roasting. The residual moisture of the component can then be reduced while or immediately after obtaining the same. Silver skins thus obtained can also be very easily mechanically comminuted.

A portion capsule according to the invention includes a base element forming an interior space bounded by an outer wall and including an opening for introducing an extraction product. In other words, the portion capsule includes a base element set up for receiving an extraction product. For example, the base element can be implemented as a cup or a sack including a closable opening, by means of which the extraction product can be introduced into the base element, that is, into the interior space formed by the base element. For example, the base element can include a base region and a circumferential side wall.

For the portion capsule according to the invention, the base element includes a composite material, wherein a component of the composite material is produced from silver skins of the coffee cherry (hereafter “silver skin component”). That is, a component of the composite material is obtained from silver skins of the coffee cherry.

The base element can particularly be made substantially of the composite material. The base element then includes further materials only in the form of layers (for example, diffusion inhibiting layers, such as PVOH), inscriptions, codes, etc. The composite material is particularly the material providing the base element with shape and stability.

When producing the silver skin component, additives can be eliminated. That is, the component can include only material of the silver skin itself.

Producing the silver skin component can include processing steps such as comminuting, drying, and/or de-oiling of the silver skins.

The composite material includes a plastic component in addition to the silver skin component. The composite material can include further components and/or additives, such as a bonding agent.

As a rule, the silver skin component and the plastic component form the principal share of mass of the composite material. That is, the mass share of the silver skin component and the plastic component can make up more than 90%, particularly more than 95% or 98% of the mass of the composite material.

The mass share of the silver skin component can be between 10% and 70%, particularly between 20% and 60%, or between 25% and 50%. For example, the mass share of the silver skin component can be 30%, 35%, 40%, or 45%. Said values are guidelines and can vary depending on the fat content and residual moisture. The range of variation can be indicated approximately as +/−5%.

The mass share of the plastic component can make up the remainder of the mass of the composite material minus the mass of the additives. Because the mass of the additives is typically a few percent, for example at or below 5%, that is, for example, 4%, 3%, 2%, or 1%, or less, the mass share of the plastic component can be between approximately 25% and 90%, between 35% and 80%, or between 45% and 75%. For example, the mass share of the plastic component can be 65-70%, 60-65%, 55-60%, or 50-55%. In addition to the share of additives, the variation range of the silver skin component must also be considered.

The silver skins can be dried for producing the silver skin component. The silver skins can particularly have residual moisture of less than 5%, particularly less than 2%, less than 1%, less than 0.5%, 0.2%, or 0.1%. The mass share of the residual moisture in unprocessed silver skins can vary and can particularly depend on the type of coffee. Investigations have determined that, for example, the mass share of residual moisture in the silver skins of the type Arabica is approximately 7-8% (Borrelli R C, Esposito F, Napolitano A, Ritieni A, Fogliano V (2004) Characterization of a new potential functional ingredient: coffee silverskin. Journal of Agricultural and Food Chemistry 52 (5):1338-1343).

The silver skins can be de-oiled for producing the silver skin component. The silver skins can particularly have a fat share of less than 10%, particularly less than 8%, 6%, 4%, or less than 2%.

The fat share in unprocessed silver skins can vary and can particularly depend on the type of coffee. Investigations have determined that, for example, the fat share in the silver skins of the type Arabica is at a relatively low 2-3% (Borrelli R C, Esposito F, Napolitano A, Ritieni A, Fogliano V (2004) Characterization of a new potential functional ingredient: coffee silverskin. Journal of Agricultural and Food Chemistry 52 (5):1338-1343).

The silver skins can be comminuted for producing the silver skin component. A maximum extent of the comminuted silver skins can particularly be less than 1 mm, particularly less than 0.75 mm or 0.5 mm. For example, the maximum extent can lie between 0.01 and 1 mm, between 0.01 and 0.5 mm, or between 0.01 and 0.3 mm.

It goes without saying that when comminuting large amounts of silver skins, not every individual comminuted silver skin can have a maximum extent as indicated above. Rather, the silver skins can be considered to be comminuted when the silver skin component includes substantially, that is, for example, at 90%, silver skins having the maximum extent indicated above.

The silver skins can particularly be mechanically comminuted.

The composite material can be produced particularly by compounding.

In one embodiment, the portion capsule includes a capsule cover attached or attachable along a circumferential edge of the opening. That is, the capsule cover is set up for closing off the opening after filling the base element with extraction product, and the ready-to-use portion capsule has a capsule cover, so that the extraction product is present in a closed, interior space of the portion capsule formed by the base element and the capsule cover.

In the present embodiment, both the base element and the capsule cover preferably include the composite material.

Both the base element and the capsule cover can particularly be made substantially of the composite material. The base element and the capsule cover then include further materials—if at all—only in the form of coatings, inscriptions, codes, etc. The composite material is particularly the material providing the base element and the capsule cover with shape and stability.

The base element and capsule cover can nevertheless differ in the properties thereof, particularly in the mechanical properties thereof.

For example, the capsule cover can be flexible while the base element is rigid. Alternatively, both the capsule cover and the base element can be rigid.

The capsule cover can vary from a simple film, such as a sealing film, or a plate, and can be implemented as a three-dimensional object and can form an outward dome, for example. The capsule cover can thus form a rigid, three-dimensional body.

In embodiments, the capsule cover is characterized in that said cover forms an outward dome radially internally from a circumferential cover flange forming an attaching part during the attaching to the circumferential side wall, wherein the dimensions of the circumferential cover flange are matched to a collar (edge, flange) of the circumferential side wall (or the base element). The capsule cover according to the present embodiment thus is differentiated from a flat cover element, for example a film-like or plate-like cover element. The cover is a three-dimensionally formed body.

The shape of the capsule cover in such embodiments can include, from outside to inside, the cover flange, a curved transition region, and a central flat region forming the actual top cover surface. Such a flat region is offset outwardly from the plane of the cover flange due to the transition region bringing about the dome. The transition region can be curved in an S-shape, for example, or can be constantly curved from an outer part, at an angle to the flange plane, to a center, flat region. The dimensions thereof are thereby selected, for example, so that the center, flat region dominates optically, in that said region is the same size as or only slightly (e.g., maximum of 10%) smaller than the area of the base region. For an embodiment of the portion capsule as an overall cuboid or cube shape, it can be provided particularly that the flat region occupies more than 60% of the diameter and accordingly at least 40% of the area.

The cover flange generally forms a circumferential area facing the capsule cover side and extending from an outer edge of the flange to a start of the dome. In some embodiments, it can be provided that the start of the dome is offset inwardly in comparison with the portion of the side wall at which the flange contacts the circumferential side wall. Such an offset can be, for example, a minimum of 0.2 mm.

The capsule cover can be perforated. In many embodiments, the capsule cover is sealed and the base element together with the capsule cover completely encloses the extraction product.

In one embodiment, the base element and capsule cover differ from each other only in shape. That is, the materials used, thicknesses, etc. are identical.

The base element and capsule cover can particularly be rigid.

A portion capsule can—depending on the concrete implementation—include further elements including the composite material or substantially made of the material, such as a screen, a means for piercing or tearing the capsule, a means for checking the liquid distribution and/or the liquid flow in the capsule, and/or a reinforcing element.

In one embodiment, the composite material is biodegradable.

This means particularly that the plastic component is biodegradable.

The composite material and the plastic component can particularly be biodegradable according to EN 13432 (as of the end of 2019) and/or ASTM 6400 (as of the end of 2019).

The filled or empty, unused or used portion capsule can accordingly be biodegradable. This is particularly the case when the mass share of the biodegradable plastic component and of the silver skin component in the composite material is very high, for example over 95% or 98%, and the mass share of the composite material in the portion capsule (without extraction product) is also very high, for example over 95% or 98%. It goes without saying that the biodegradability of the portion capsule is even better if the additives, layers, inscriptions, etc., used are also biodegradable or are nearly negligible in terms of mass share.

The portion capsule can be completely biodegradable.

The plastic component can include a bio-plastic or be made of a bio-plastic. Polybutylene adipate-terephthalate (PBAT), polylactide (PLA), polybutylene succinate (PBS), polyhydroxyalkanoate (PHA, such as polyhydroxybutyrate (PHB)), or a starch-based plastic are examples of suitable bio-plastics. A plastic component including a plurality of bio-plastics, for example a plurality of the bio-plastics listed above, is possible.

In one embodiment, the composite material includes a plastic component including polybutylene adipate terephthalate (PBAT), polylactide (PLA), polyvinyl alcohol (PVOH), or a combination of the materials, particularly polybutylene adipate terephthalate (PBAT) and polylactide (PLA).

The plastic component can particularly be made substantially or exclusively (except for unavoidable impurities) of polybutylene adipate terephthalate (PBAT), polylactide (PLA), polyvinyl alcohol (PVOH), or of a combination of said materials, particularly polybutylene adipate terephthalate (PBAT) and polylactide (PLA). In these cases, the plastic component is a biodegradable plastic component as described above.

In a preferred embodiment, the plastic component is made of PBAT and PLA.

The plastic component can particularly be Ecoflex® or Ecovio® (preferred) from BASF or comparable plastics offered under different names.

If the plastic component is PVOH, the composite material can be made of PVOH, the silver skin component, and at most additional additives, wherein the silver skin component can constitute a mass share of 10% to 50%, for example 20% to 50%, or 30% to 50% of the composite material.

In one embodiment, the base element is cup-like and has a rectangular, particularly square, basic shape.

In other words, the base element includes a cup axis along which the opening extends. The base element then has a rectangular, particularly square, basic shape in a section perpendicular to the cup axis.

The base element can have the shape of a cuboid, particularly of a cube, wherein one side of the cuboid or cube is open.

The capsule cover can have a shape enclosing the opening of the cuboid or cube. That is, the capsule cover can have substantially the shape of a side of the cuboid or cube formed by the base element (for example, except for elements necessary for attaching and/or the functionality of the capsule cover).

It has been found that a portion capsule substantially made of the composite material (without the extraction product) and having a rectangular, particularly square, and cuboid, particularly cubic, basic shape is particularly well suited for existing systems set up for portion capsules of said shape for preparing beverages.

According to one aspect of the invention, a method for producing a portion capsule including a base element is further made available.

The base element can include each of the previously described properties, particularly properties with respect to composition, shape, and biodegradability.

A method according to the invention includes the steps:
providing a composite material; and
reshaping the composite material into the base element; wherein a component of the composite material is produced from silver skins of the coffee cherry (“silver skin component”).

The reshaping can particularly include injection molding or thermoforming. Other reshaping processes are conceivable, such as extruding.

The providing of the composite material can include providing the silver skin component, a plastic component, and at least one additive.

The silver skin component, plastic component, and additive can be provided at the mass share indicated above.

The plastic component can be one of the plastic components described above.

The additive can be one of the additives described above, particularly a bonding agent.

Providing the composite material can include compounding.

The providing of the composite material can include at least one of the steps, described above, of comminuting the silver skin, drying the silver skin, and de-oiling the silver skin.

In one embodiment, the silver skins required for producing the silver skin component are separated from the coffee beans during roasting of the coffee beans, wherein the silver skins are fed to a processing line for producing the base element and at most the capsule cover, and wherein the roasted coffee beans are fed to a processing line for producing the extraction product. In addition or alternatively, the silver skins can be separated during decaffeinating.

The roasted coffee beans can particularly be fed to a processing line for filling the base element.

The processing lines can be present entirely at the location of roasting (and at most decaffeinating). That is, the processing lines begin directly downstream of roasting (and/or decaffeinating) and end at filling the processed, roasted coffee beans into the produced base element at the roasting location. The sealing of the portion capsules by means of the capsule cover can then take place at the same location.

Feeding in the separated silver skins and the roasted coffee beans to the corresponding processing lines can be done by means of automation.

In embodiments for which a capsule cover is provided, a capsule cover as described in detail above can particularly be provided.

The method for producing a portion capsule can include providing the extraction product.

The method for producing a portion capsule can include filling the extraction product into the base element and sealing the base element by means of the capsule cover.

One consideration of the invention relates to a composite material.

The composite material is particularly a composite material for portion capsules. Certain requirements with respect to food product compatibility, sealing properties, thermal resistance, behavior under pressure, processing options, etc. are thereby implied.

The composite material according to the invention includes a first component and a second component, the first component being a plastic (“plastic component”) and the second component being produced from silver skins of the coffee cherry (“silver skin component”).

The composite material typically includes at least one additive in addition to the silver skin component and the plastic component.

The silver skin component, plastic component, and additive can be present in the composite material at the mass share indicated above.

The plastic component can be one of the plastic components described above.

The first component, that is, the plastic component, can particularly be a biodegradable component, particularly a biodegradable plastic component according to EN 13432 (as of the end of 2019) and/or ASTM 6400 (as of the end of 2019).

In one embodiment, the first component, that is, the plastic component, includes polybutylene adipate terephthalate (PBAT), polylactide (PLA), polyvinyl alcohol (PVOH), or a combination of said materials, particularly polybutylene adipate terephthalate (PBAT) and polylactide (PLA).

The first component (the plastic component) can include PBAT, PLA, and/or PVOH as described above.

The first component (the plastic component) can particularly be made of PBAT and PLA, except for contaminants.

The first component (the plastic component) can particularly be Ecoflex® or Ecovio® (preferred) from BASF or a comparable plastic offered under a different name.

The additive can be one of the additives described above at a mass share as described above.

The composite material can particularly be a compounded composite material. That is, producing the composite material can include compounding and the composite material can have properties arising therefrom, particularly with respect to the structure thereof.

The silver skin component can be present in the composite material in a manner resulting from one or more of the steps described above, “comminuting the silver skins”, “drying the silver skins”, and “de-oiling the silver skins”.

One consideration of the invention relates to the use of the composite material according to the invention in any of the disclosed embodiments for producing the base element and optionally the capsule cover.

The invention further relates to the use of the composite material according to the invention in any of the disclosed embodiments for producing a portion capsule.

One consideration of the invention relates to a method for producing the composite material according to the invention in one of the embodiments described above. That is, one consideration of the invention relates to a method for producing a composite material, particularly a composite material for portion capsules.

The method for producing the composite material includes the steps:
Providing the first component.
   That is, a plastic component as described above is provided. The plastic component is particularly provided at a quantity resulting in a quantity share of the composite material as indicated above.
   The plastic component can be one of the previously listed plastic components.
Providing the second component.
   That is, a silver skin component is provided as described above. The silver skin component is particularly provided at a quantity resulting in a quantity share of the composite material as indicated above.
   The silver skin component can further be provided with respect to the maximum extent of silver skin residues present, or to the moisture content and/or fat share as indicated above. The method for producing can include a corresponding comminuting step, a corresponding drying step, and/or a corresponding de-oiling step.
Compounding the first and second components.

In one embodiment, the method for producing the composite material includes a step wherein the silver skins and the coffee beans are separated. The separating takes place particularly during roasting. In this case, the roasting process can be set up so that a separate drying step following the obtaining of the silver skin is no longer necessary.

In addition or alternatively, the separating can take place during decaffeinating.

The method for producing the composite material can additionally include the comminuting step.

The method for producing the composite material can further include the de-oiling step.

### BRIEF DESCRIPTION OF THE DRAWINGS

Embodiment examples of the invention are described below with reference to the drawing figures, wherein:

FIG. 1 shows a portion capsule;

FIG. 2 shows a base element of a portion capsule according to FIG. 1;

FIG. 3 shows a capsule cover of a portion capsule according to FIG. 1, matched to a base element according to FIG. 2;

FIG. 4 illustrates a method for producing a coffee portion capsule ready for consumption.

### DETAILED DESCRIPTION OF THE INVENTION

Identical reference numerals in the figures indicate identical or analogous elements.

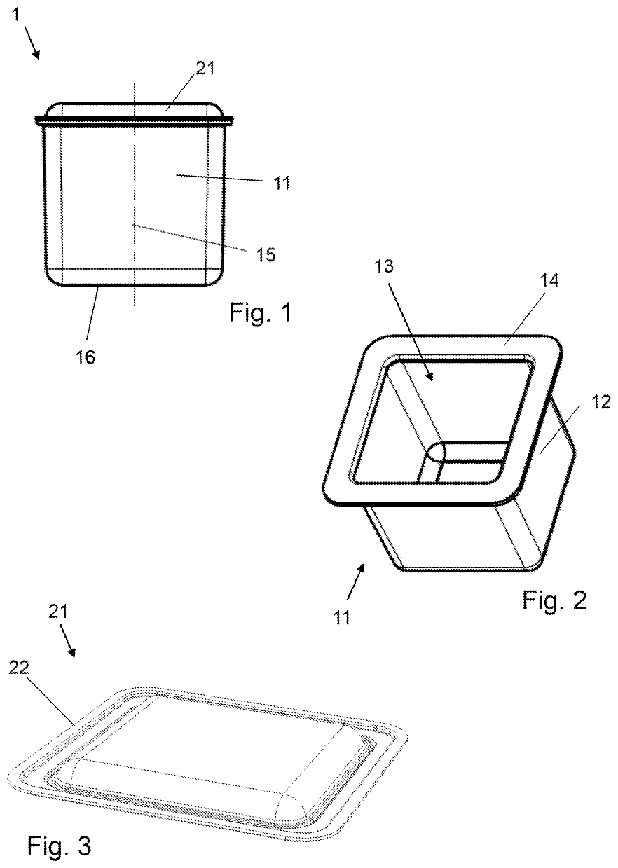

The example portion capsule 1 according to FIG. 1 includes a base element 11 in the form of a cup (having a cup axis 15) and a capsule cover 21 attached thereto along a circumferential flange 14, together forming an outer capsule wall and defining an interior capsule space. The base element 11 forms a slightly domed capsule base 16 and a circumferential side wall 12, as is per se known.

The base element 11 and capsule cover 21 are produced from a composite material compounded from a component obtained from silver skins of the coffee cherry and from a plastic component having a bonding agent admixed therein. The plastic component is Ecovio® from BASF. The bonding agent is Licocene PP MA 7452.

The capsule cover 21 is attached to the base element 11 in a known manner, for example by means of ultrasonic welding or potentially by gluing.

FIG. 2 shows a detail view of the base element 11. The base element 11 is cup-like and has a square basic shape. That is, the base element substantially has the shape of a cube, one of the six sides of the cube being missing and forming an opening 13. Extraction product can be introduced into the interior space of the base element and thus into the interior capsule space via the opening.

In the embodiment shown, the circumferential edge 14 to which the capsule cover 21 can be attached, the rounded edges, and at most slightly domed sides deviate from the shape of a cube.

FIG. 3 shows a detail view of the capsule cover 21. In the embodiment shown, the cover is made of the same composite material having the same thickness as the base element 11.

The capsule cover 21 includes a circumferential flange 22 matched to the edge 14 of the base element 11, so that the capsule cover 21 can seal off the base element 11 in a fluid-tight manner when appropriately attached.

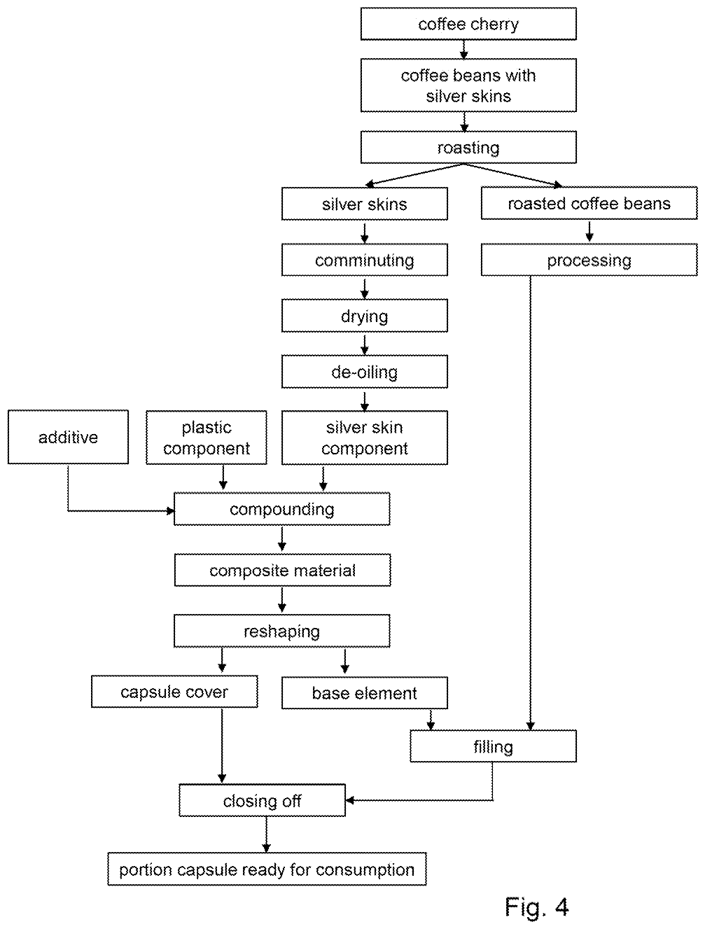

FIG. 4 shows schematically a method for producing a portion capsule ready for consumption. In addition to the use according to the invention of the silver skins, various optional features are shown in the schema.

The method shown starts with providing coffee cherries. Coffee beans (seeds of the coffee cherries) are obtained from the same. After obtaining the coffee beans, the silver skin still encloses the coffee beans.

In a next step, the coffee beans are roasted. Because the coffee beans expand at the start of the roasting process, the silver skins burst away from the coffee beans.

The silver skins are separated from the coffee beans in a next step and then comminuted, dried (not necessary, depending on the roasting process), and at most de-oiled. That is, a material obtained from the silver skins is produced and is suitable as a component in a compounding method and as a component of a composite material.

The “silver skin component” is mixed (compounded) with a plastic component, preferably a biodegradable plastic component such as Ecovio®, and further additives for improving the properties of the resulting composite material.

The resulting composite material is then used for forming the base element 11 and optionally the capsule cover 21 and/or other elements of the portion capsule. The resulting composite material is particularly suitable for use in an injection molding process or for thermoforming.

The roasted coffee beans from which the silver skins have been separated are also processed further, thus producing the extraction product.

The coffee beans are particularly ground and at most decaffeinated.

In a further step, the extraction product thus obtained is filled into the base element thus produced.

Finally, the base element 11 filled with the extraction product is closed off by means of the capsule cover 21 produced during the method or provided, for example by means of ultrasonic welding.

After closing off, the portion capsule 1 is available and ready for consumption.

Further steps, or intermediate steps, particularly applying impermeable layers, particularly diffusion inhibiting layers, cleaning steps, applying labels, etc. are conceivable.

1. A portion capsule comprising a base element forming an interior space bounded by an outer wall, the base element comprising an opening, and the base element comprising a composite material, and wherein a component of the composite material is produced from coffee cherry silver skins.

2. The portion capsule according to claim 1, further comprising a capsule cover, the capsule cover being attached or attachable along a circumferential edge of the opening and wherein the base element and the capsule cover comprise the composite material.

3. The portion capsule according to claim 1, wherein the composite material is biodegradable.

4. The portion capsule according to claim 1, wherein the composite material comprises a plastic component comprising polybutylene adipate terephthalate (PBAT), polylactide (PLA), polyvinyl alcohol (PVOH) or polybutylene adipate terephthalate (PBAT), and polylactide (PLA).

5. The portion capsule according to claim 1, wherein the base element is cup-like and has a rectangular, particularly square, basic shape.

6. A method for producing a portion capsule, the portion capsule comprising a base element and the method comprising the following steps:
providing a composite material
reshaping the composite material into the base element
wherein a component of the composite material is produced from coffee cherry silver skins.

7. The method according to claim 6, wherein the silver skins are separated from the coffee beans during roasting of the coffee beans, wherein the silver skins are fed to a processing line for producing a base element and wherein the roasted coffee beans are fed to a processing line for producing an extraction product.

8. A composite material for portion capsule, a first component of the composite material being a plastic, characterized in that a second component of the composite material is produced from coffee cherry silver skins.

9. The composite material according to claim 8, wherein the composite material is biodegradable.

10. The composite material according to claim 8, wherein the first component comprises polybutylene adipate terephthalate (PBAT), polylactide (PLA), polyvinyl alcohol (PVOH) or polybutylene adipate terephthalate (PBAT), and polylactide (PLA).

11. A method for producing a composite material for portion capsules according to any claim 8, wherein the first component and the second component are compounded.

12. The method according to claim 11, comprising the steps
separating silver skins and coffee beans
comminuting the silver skins.
